(19) United States
(12) Patent Application Publication
(10) Pub. No.: US 2005/0203205 A1
(43) Pub. Date: Sep. 15, 2005

(54) Composition of matter comprising UV curable materials incorporating nanotechnology for the coating of fiberglass

(76) Inventor: Sally Judith Weine Ramsey, Tallmadge, OH (US)

Correspondence Address: WILSON SONSINI GOODRICH & ROSATI, 650 PAGE MILL ROAD, PALO ALTO, CA, 94304-1050, US

(21) Appl. No.: 10/799,821

(22) Filed: Mar. 13, 2004

(51) Int. Cl. C08G 2/00

(52) U.S. Cl. 522/178

(57) ABSTRACT

A composition of matter incorporating nanotechnology with UV curable materials for the coating of fiberglass. A one-part, substantially solvent-free coating composition for applying to fiberglass substrates, consisting essentially of: a polymerizable compound which comprises a mixture of acrylates, photoinitiator or a photoinitiator mix, silicon dioxide monospheres, and surfactant or mixture of surfactants.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of coatings and more specifically to a composition of matter comprising UV curable materials incorporating nanotechnology for the coating of fiberglass. Fiberglass used for architectural purposes is exposed to sunlight, causing yellowing and deterioration. To prevent yellowing and deterioration it is desirable to apply a coating to the fiberglass. It is further desirable that such a coating be resistant to water, solvents, abrasion, and other hazards that might cause deterioration. Up to now two part urethane coatings have been used for this purpose. These coatings are a source of emission of volatile organic components. Therefore it is desirable to replace them with essentially solvent free coatings. UV curable coatings have been developed for this purpose. Additionally fiberglass may be treated to cause it to be fire retardant. Such treatment may interfere with the curing of UV curable coatings to a hard surface. The incorporation of nanotechnology permits the achievement of a hard surface, while increasing fire retardance, thus presenting a significant improvement over previous conventional and UV curable technology.

### BRIEF SUMMARY OF THE INVENTION

The primary object of the invention is to eliminate emissions of volatile organics in the coating of fiberglass.

Another object of the invention is to provide a rapid production time.

Another object of the invention is to save space on the production floor.

A further object of the invention is to save energy costs.

Yet another object of the invention is to prevent damage of fiberglass from UV radiation from sunlight.

Still yet another object of the invention is to prevent damage of fiberglass by abrasion.

Another object of the invention is to resist damage from water, even at elevated temperatures.

Another object of the invention is to resist damage from solvents.

A further object of the invention is to provide 100% adhesion to fiberglass, including fire retardant fiberglass.

Yet another object of the invention is to a provide a hard glossy surface to fiberglass, including fire retardant fiberglass.

Other objects and advantages of the present invention will become apparent from the following descriptions, taken in connection with the accompanying drawing, wherein, by way of illustration and example, an embodiment of the present invention is disclosed.

In accordance with a preferred embodiment of the invention, there is disclosed a composition of matter comprising UV curable materials incorporating nanotechnology for the coating of fiberglass 1. A one-part, substantially solvent-free coating composition for applying to a substrate, consisting essentially of: from about 60 to 80% by weight, based on total composition weight, of a polymerizable compound which comprises a mixture of acrylates, the acrylate mixture comprising an aliphatic urethane acrylate and a mixture of acrylate monomers, from 10 to 30% silicon dioxide monospheres of a diameter of approximately 20 nanometers, and from about 1 to 10% of an organic photoinitiator which initiates a polymerization reaction in the composition when it is exposed to ultraviolet light, without the use of added heat for either evaporation or postcure. 2. The composition of claim 1, where the mixture of acrylate monomers is selected from a group consisting of isobornyl acrylate, tetrahydrofurfuryl acrylate, propoxylated glyceral triacrylate, 1,6-hexanediol diacrylate, dipropylene glycol diacrylate, tripropylene glycol diacrylate, neopentyl glycol propoxylate diacrylate, trimethylopropane triacrylate, trimethylopropane ethoxylate triacrylate, pentaerythritol alkoxylate tetraacrylate, and dimethylopropane tetraacrylate. 3. The composition of claim 1, where the photoinitiator is selected from a group comprising 1-hydroxycyclohexyl phenyl ketone, 2-hydroxy-2-methyl-1-phenyl-propan-1-one, and mixtures thereof. 4. The composition of claim 1, further comprising 0.01-2.0% of a surfactant or mixture of surfactants. 5. The composition of claim 1, where the aliphatic urethane may be mono, di, tri, or tetrafunctional.

### BRIEF DESCRIPTION OF THE DRAWINGS

The drawing constitutes a part of this specification and include an exemplary embodiment to the invention, which may be embodied in various forms. It is to be understood that in some instances various aspects of the invention may be shown exaggerated or enlarged to facilitate an understanding of the invention.

FIG. 1 is a flow chart of the components that comprise the composition.

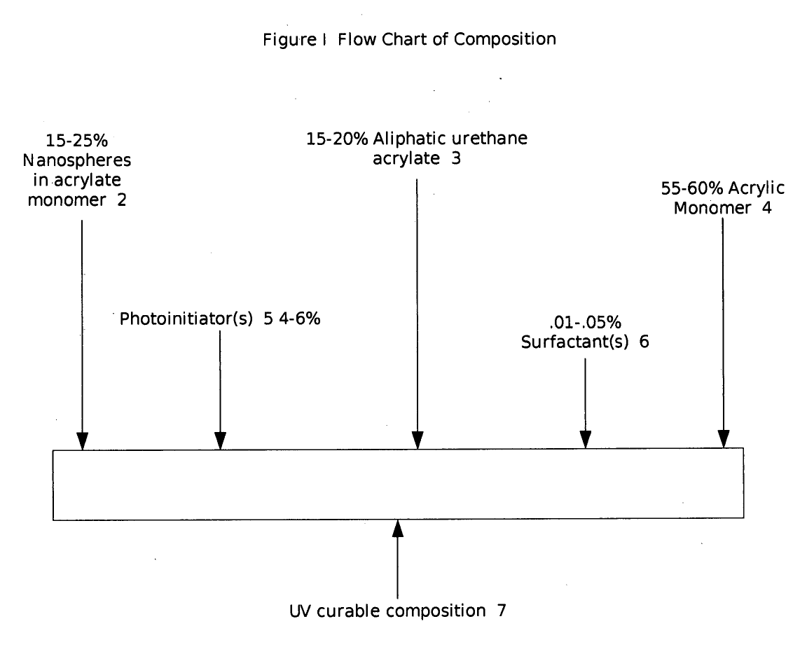

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. One part UV curable compositions are well known. The use of an aliphatic urethane acrylates to produce non-yellowing coatings is known. Using acrylic monomers as reactive diluents is known. the use of photoinitiators to cure polymerizable compositions is known. Reference patent # 4721734. Using a UV curable coating on fiberglass is known. Reference patent # 5,733,607. Producing a substantially solvent-free UV curable composition that can cure to a hard surface on fire retardant fiberglass, while providing protection against sunlight, water, solvents, and abrasion, is not known. Incorporating silicon dioxide nanospheres as a component to produce such a composition is not known. This invention takes established UV curable technology and combines it with nanotechnology to produce a coating for fiberglass with superior characteristics of water resistance, especially at elevated temperatures, solvent resistance, abrasion resistance, hardness, and adhesion. This invention is particularly superior for coating fire retardant fiberglass. As previously noted, the invention is a one-part, substantially solvent-free coating composition for applying to a substrate, consisting essentially of:

from about 60 to 80% by weight, based on total composition weight, of a polymerizable compound which comprises a mixture of acrylates, the acrylate mixture comprising an aliphatic urethane acrylate and a mixture of acrylate monomers, from 10 to 30% silicon dioxide monospheres of a diameter of approximately 20 nanometers, and from about 1 to 10% of an organic photoinitiator which initiates a polymerization reaction in the composition when it is exposed to ultraviolet light, without the use of added heat for either evaporation or postcure.

In a preferred embodiment hereof, the coating composition hereof comprises 15-20% aliphatic urethane acrylate, 55-60% mixture of acrylic monomers, 15-25% silicon dioxide monospheres, 4-6% photoinitiator or photoinitiator mix and 0.01-0.05% surfactant or surfactant mix.

The mixture of acrylate monomers is selected from a group consisting of isobornyl acrylate, tetrahydrofurfuryl acrylate, propoxylated glyceral triacrylate, hexandiol diacrylate, dipropylene glycol diacrylate, tripropylene glycol diacrylate, neopentyl glycol propoxylate diacrylate, trimethylopropane triacrylate, trimethylopropane ethoxylate triacrylate, pentaerythritol alkoxylate tetraacrylate, and dimethylopropane tetraacrylate.

The photoinitiator is selected from a group comprising 1-hydroxycyclohexyl phenyl ketone, 2-hydroxy-2-methyl-1-phenyl-propan-1-one, and mixtures thereof.

The invention further comprises 0.01-2.0% of a surfactant or mixture of surfactants.

The aliphatic urethane previously cited may be a mono, di, tri, or tetrafunctional acrylate.

The composition of the present invention may be cured by medium pressure mercury lamp, microwave powered mercury lamp, or radio-wave powered mercury lamp.

The composition of this invention is a significant improvement over prior art because of the incorporation of nanospheres to produce a hard cure on a substrate on which such a cure was previously unattainable through UV curable technology.

Possible methods of application include but are not limited to spraying, brushing, and rolling.

While the invention has been described in connection with a preferred embodiment, it is not intended to limit the scope of the invention to the particular form set forth, but on the contrary, it is intended to cover such altematives, modifications, and equivalents as may be included within the spirit and scope of the invention as defined by the appended claims.

1. A composition of matter comprising UV curable materials incorporating nanotechnology for the coating of fiberglass
1. A one-part, substantially solvent-free coating composition for applying to a substrate, consisting essentially of:
from about 60 to 80% by weight, based on total composition weight, of a polymerizable compound which comprises a mixture of acrylates, the acrylate mixture comprising an aliphatic urethane acrylate and a mixture of acrylate monomers, from 10 to 30% silicon dioxide monospheres of a diameter of approximately 20 nanometers, and from about 1 to 10% of an organic photoinitiator which initiates a polymerization reaction in the composition when it is exposed to ultraviolet light, without the use of added heat for either evaporation or postcure.

2. The composition of claim 1, where the mixture of acrylate monomers is selected from a group consisting of isobornyl acrylate, tetrahydrofurfuryl acrylate, propoxylated glyceral triacrylate, 1,6-hexandiol diacrylate, dipropylene glycol diacrylate, tripropylene glycol diacrylate, neopentyl glycol propoxylate diacrylate, trimethylopropane triacrylate, trimethylopropane ethoxylate triacrylate, pentaerythritol alkoxylate tetraacrylate, and dimethylopropane tetraacrylate.

3. The composition of claim 1, where the photoinitiator is selected from a group comprising 1-hydroxycyclohexyl phenyl ketone, 2-hydroxy-2-methyl-1-phenyl-propan-1-one, and mixtures thereof.

4. The composition of claim 1, further comprising 0.01-2.0% of a surfactant or mixture of surfactants.

5. The composition of claim 1, where the aliphatic urethane may be mono, di, tri, or tetrafunctional.
